(19) United States
(12) Patent Application Publication
(10) Pub. No.: US 2012/0120934 A1
(43) Pub. Date: May 17, 2012

(54) METHOD FOR TETHERING NETWORK CONNECTION, METHOD FOR CONNECTING TO NETWORK, AND WIRELESS COMMUNICATION GROUP APPLYING THE SAME

(75) Inventor: Seong-ho CHO, Seoul (KR)

(73) Assignee: Samsung Electronics Co., Ltd.

(21) Appl. No.: 13/296,849

(22) Filed: Nov. 15, 2011

(30) Foreign Application Priority Data
Nov. 15, 2010 (KR) 10-2010-0113554

(51) Int. Cl. H04W 84/02

(52) U.S. Cl. 370/338

(57) ABSTRACT

A method for tethering a network connection, a method for connecting a terminal included in a wireless communication group to an external network is provided. The method includes receiving routing information from a first terminal having an external network tethering function for connecting a second terminal in the wireless communication group with the external network through the first terminal; updating a pre-stored routing table according to the received routing information; and allowing the second terminal of the wireless communication group to use the external network through the first terminal with the updated routing table.

### PRIORITY

This application claims priority to Korean Patent Application No. 10-2010-0113554, filed on Nov. 15, 2010, in the Korean Intellectual Property Office, the entire disclosure of which is incorporated herein by reference.

### BACKGROUND OF THE INVENTION

1. Field of the Invention

The present invention relates generally to a method for tethering a network connection, a method for connecting to a network, and a wireless communication group applying the same, and more particularly, to a method for tethering a network connection and a method for connecting to a network in a Wi-Fi Peer-to-Peer (P2P) environment, and a wireless communication group applying the same.

2. Description of the Related Art

With the development of wireless technologies, it is now possible for various devices located within a local area to wirelessly communicate with one another. Such wireless communication methods include Wi-Fi, Bluetooth, Broadband Radio Access Networks (BRAN), HiperLAN/1 and HyperLAN/2, and the like.

FIG. 1 is a block diagram illustrating a Wi-Fi wireless communication network system. Generally, a wireless communication operation mode of the Wi-Fi wireless communication network system is divided into an infrastructure mode and an Ad-Hoc mode. Specifically, if the wireless communication operation mode is in infrastructure mode, a first terminal 120 and a second terminal 130 in the wireless communication network system wirelessly exchange data through an Access Point (AP) 110. The first terminal 120 and the second terminal 130 may exchange data with an external device through an Ethernet 100. However, if the wireless communication operation mode is the Ad-Hoc mode, the first terminal 120 and the second terminal 130 directly exchange data with each other without passing through the AP 110.

However, in order to provide a tethering service for an external network in a Wi-Fi wireless communication group, the wireless communication operation mode should be changed to Ad-Hoc mode. However, a user is constantly required to change infrastructure mode to Ad-Hoc mode.

In order to solve the above problem, the Wi-Fi P2P (or Wi-Fi Direct) method allowing a wireless communication group to connect to a network without the AP 110 has been developed. In such a Wi-Fi P2P environment, if a group owner terminal of the wireless communication group connects to an external network, other terminals belonging to the communication group are also allowed to connect to the external network by “tethering.”

The group owner terminal in the Wi-Fi P2P environment transmits a beacon message periodically like the AP, and transmits packets to the terminals in the communication group. Therefore, the group owner terminal increases power consumption. Accordingly, it is preferable that a fixed terminal such as a TeleVision (TV) serves as a group owner. However, if a communication terminal having difficulty in connecting to a network such as a TV becomes the group owner, the other communication terminals may also have difficulties connecting to the network.

Accordingly, there is a demand for a method, in which, if a communication terminal other than a group owner among terminals belonging to a wireless communication group is able to connect to a network, the other communication terminals of the group including the group owner terminal can connect to the network.

### SUMMARY OF THE INVENTION

One or more illustrative embodiments of the present invention may overcome the above disadvantages and other disadvantages not described above. However, it is understood that one or more embodiments of the present invention are not required to overcome the disadvantages described above, and may not overcome any of the problems described above.

In accordance with one embodiment of the present invention, a method for connecting a terminal included in a wireless communication group to an external network is provided. The method includes receiving routing information from a first terminal having an external network tethering function for connecting a second terminal in the wireless communication group with the external network through the first terminal; updating a pre-stored routing table according to the received routing information; and allowing the second terminal of the wireless communication group to use the external network through the first terminal with the updated routing table.

In accordance with another embodiment of the present invention, a method for tethering a network connection is provided. The method includes transmitting routing information to a group owner terminal by a first terminal that provides an external network tethering function among a plurality of terminals of a wireless communication group; updating a routing table based on the routing information by the group owner terminal; and tethering according to the updated routing table such that the group owner terminal and a second terminal of the wireless communication group connect to the external network by the first terminal.

According to an aspect of an embodiment of the present invention, a method for connecting to a network connection of a terminal included in a wireless communication group is provided. The method includes identifying a first terminal that provides an external network tethering function for connecting with the external network to a second terminal of the wireless communication group; transmitting, to the second terminal, a group owner change message including information indicating that the first terminal will be changed to a new group owner; and connecting the second terminal to the external network by using the new group owner.

According to an aspect of another embodiment of the present invention, a wireless communication system, The system includes a first terminal for providing an external network tethering function; a group owner terminal for identifying the first terminal, transmits a group owner change message comprising information indicating that the first terminal will be changed to a new group owner to a plurality of terminals of the wireless communication group, and is tethered to the first terminal and connects to the external network; and a second terminal, for, if the group owner change message is received, tethering to the first terminal which is the new group owner and connects to the external network.

According to an aspect of still another embodiment of the present invention, a method for tethering a network connection of a terminal included in a wireless communication group is provided. The method includes receiving, from a group owner terminal, a request in which the tethering function for connecting with an external network is provided; informing the group owner terminal that it is possible to provide the tethering function to work as a new group owner; and connecting a terminal connecting to the group owner terminal to the external network.

Additional aspects and advantages of the embodiments of the present invention will be set forth in the detailed description, will be obvious from the detailed description, or may be learned by practicing the embodiments of the present invention.

### BRIEF DESCRIPTION OF THE DRAWINGS

The above and/or other aspects will be more apparent by describing in detail embodiments of the present invention, with reference to the accompanying drawings, in which:

FIG. 1 is a block diagram illustrating a related-art Wi-Fi wireless communication network system;

FIGS. 2 and 3 illustrate a wireless communication group to tether a network connection using routing information according to an embodiment of the present invention;

FIG. 4 is a flowchart illustrating a method for tethering a network connection using routing information according to an embodiment of the present invention;

FIGS. 5 and 6 illustrate a wireless communication group to connect to a network by changing a group owner according to another embodiment of the present invention; and

FIG. 7 is a flowchart illustrating a method for tethering a network connection by changing a group owner according to another embodiment of the present invention.

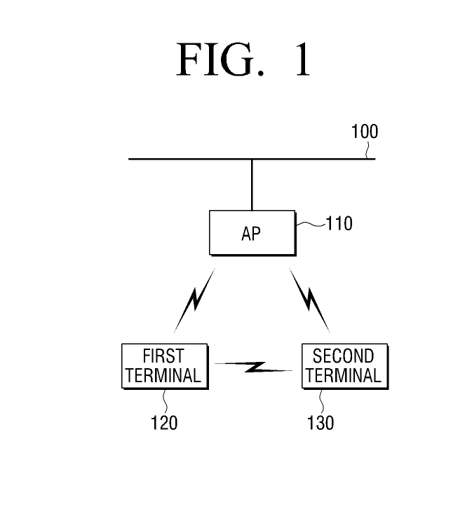

### DETAILED DESCRIPTION OF EMBODIMENTS OF THE PRESENT INVENTION

Hereinafter, illustrative embodiments of the present invention will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the embodiments. Thus, it is apparent that the embodiments of the present invention can be carried out without those specifically defined matters. Also, functions or elements known in the related art are not described in detail since they would obscure the embodiments of the present invention with unnecessary detail.

### 1. Method for Tethering Network Connection Using Routing Information

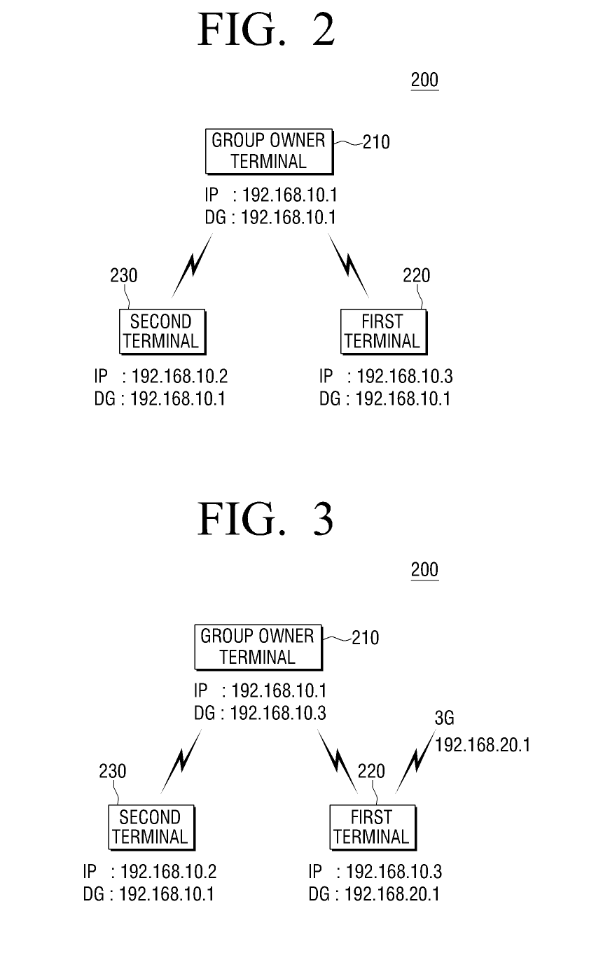

FIGS. 2 and 3 illustrate a wireless communication group 200 to tether a network connection using routing information according to an embodiment.

As shown in FIG. 2, the wireless communication group 200, according to an embodiment of the present invention includes a group owner terminal 210, a first terminal 220, and a second terminal 230. The wireless communication group 200 refers to a communication group of a Wi-Fi P2P or Wi-Fi direct environment. The communication group of the Wi-Fi P2P environment does not require a separate AP unlike a traditional Wi-Fi communication group, and the group owner terminal 210 performs the role of the AP of a traditional Wi-Fi communication group.

The group owner terminal 210 periodically transmits a beacon message and transmits packets to the other terminals 220 and 230 of the group, like the AP of the traditional Wi-Fi wireless communication group.

Moreover, if the group owner terminal 210 provides a tethering function to tether external network connection, the group owner terminal 210 tethers such that not only the group owner terminal 210 itself but also the first and the second terminals 220 and 230 connect to the external network. The tethering function refers to a function of one terminal belonging to a wireless communication group to allow the other terminals to connect to an external network.

But if the group owner terminal 210 does not provide the tethering function, it is checked whether there is the first terminal 220 that provides the tethering function among a plurality of terminals of the wireless communication group 200. If the first terminal 220 provides the tethering function, the group owner terminal 210 receives routing information from the first terminal 220 through a communication unit (not shown). The group owner terminal 210 updates a routing table stored in a storage unit (not shown) according to the routing information under control of a controller (not shown), and provides the updated routing table to the second terminal 230 that is unable to connect to the external network among the terminals belonging to the wireless communication group 200. The group owner terminal 210 routes the second terminal 230 to the first terminal 220 according to the updated routing table, and allows the second terminal 230 to connect to the external network through the first terminal 220.

The group owner terminal 210 is one communication terminal among the terminals of the wireless communication group 200. One communication terminal is not always a fixed group owner 210 and another communication terminal may be changed to the group owner.

The first and the second terminals 220 and 230 are wireless communication terminals that are able to connect to the external network through the group owner terminal 210 or directly. The first terminal 220 may provide the tethering function for the network.

If the group owner terminal 210 provides the tethering function for the external network, the first and the second terminals 220 and 230 are routed to the group owner terminal 210 and, thus, they are able to connect to the external network.

However, if the group owner terminal 210 does not provide the tethering function for the external network, the first terminal 220 providing the tethering function transmits the routing information to the group owner terminal 210 through the communication unit (not shown). The routing information includes IP information of the first terminal 220. If the second terminal 230, which is unable to connect to the external network, among the terminals belonging to the wireless communication group 200, connects to the first terminal 220 through the group owner terminal 210 using the updated routing table, the first terminal 220 provides the tethering function to the second terminal 230 so that the second terminal 230 can connect to the external terminal.

If the group owner terminal 210 does not provide the tethering function and the first terminal 220 provides the tethering function, the second terminal 230 receives the updated routing table from the group owner terminal 210 through the communication unit (not shown), and searches for a communication terminal that provides the tethering function using gateway information stored on the received routing table. If the first terminal 220 providing the tethering function is searched for, the second terminal 230 is tethered to the first terminal 220 through the group owner terminal 210 and thus connects to the external network.

The group owner terminal 210, the first terminal 220, and the second terminal 230 may establish a home wireless network environment. For example, the group owner terminal 210 may be an Internet Protocol TV (IPTV), and the first terminal 220 and the second terminal 230 may be wireless terminal devices such as a mobile phone, an MP3 player, a Portable Medial Player (PMP), and an electronic album. However, this is merely an example and the present invention may be applied to any other wireless terminal device.

Hereinafter, a method for tethering network connection using routing information of the wireless communication group 200 according to an embodiment of the present invention will be explained with reference to FIGS. 2 to 4.

If the group owner terminal 210 of the wireless communication group 200 provides the tethering function, the first terminal 220 and the second terminal 230 are routed to the group owner terminal 210 so that they can connect to the external network.

However, if the group owner terminal 210 does not provide the tethering function, neither the group owner terminal 210 nor the first terminal 220 and the second terminal 230 may connect to the external network. More specifically, when the group owner terminal 210 has an IP address of 192.168.10.1 and a default gateway (DG) of 192.168.10.1, the first terminal 220 has an IP address of 192.168.10.3 and a DG of 192.168.10.1, and the second terminal 230 has an IP address of 192.168.10.2 and a DG of 192.168.10.1. As shown in FIG. 2, if the group owner terminal 210 does not provide the tethering function, the first terminal 220 and the second terminal 230 are not able to connect to the external network despite being routed to the group owner terminal 210, since the group owner terminal 210 is not connected to the external network.

However, according to an embodiment of the present invention, if the group owner terminal 210 does not provide the tethering function for the external network, but if the first terminal 220 provides the tethering function, the first terminal 220 transmits routing information to the group owner terminal 210. Also, the group owner terminal 210 updates the routing table based on the routing information so that the group owner terminal 210 and the second terminal 230 of the wireless communication group 200 can also connect to the external network.

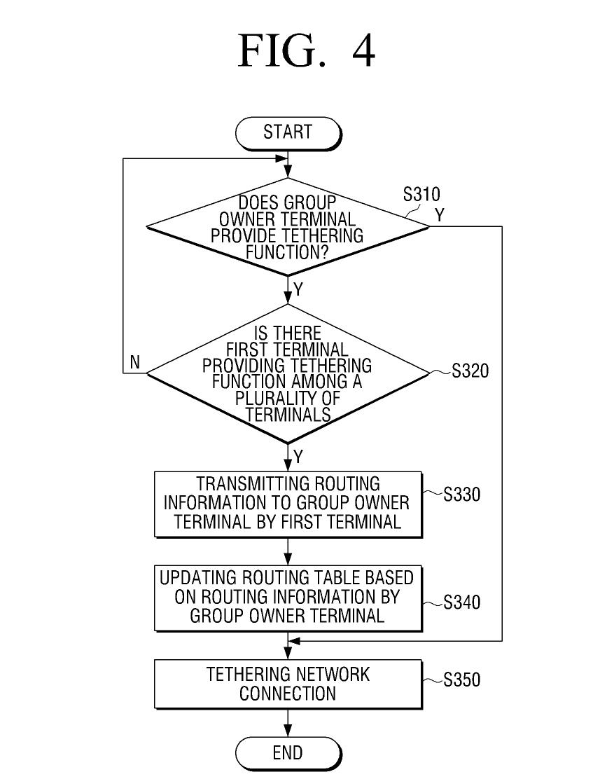

Hereinafter, a method for tethering a network connection using routing information will be explained with reference to FIG. 4.

FIG. 4 is a flowchart illustrating a method for tethering a network connection using routing information according to an embodiment.

First, in step S310, the wireless communication group 200 checks whether the group owner terminal 210 provides the tethering function or not. If the group owner terminal 210 provides the tethering function, in step S350, the group owner terminal 210 tethers network connection in a related-art wireless communication method of a Wi-Fi P2P environment, so that the first terminal 220 and the second terminal 230 can connect to the external terminal.

However, if the group owner terminal 210 does not provide the tethering function, in step S320, the group owner terminal 210 checks whether the first terminal 220 that provides the tethering function among the plurality of terminals of the wireless communication group exists. It is then determined whether the first terminal 220 providing the tethering function exists by searching for the first terminal 220 connected to the network by the group owner terminal 210 or by informing the group owner terminal 210 that the first terminal 220 can provide the tethering function, when the first terminal 220 connects to the network.

If there is the first terminal 220 providing the tethering function, in step S330, the first terminal 220 transmits the routing information to the group owner terminal 210. The routing information includes IP address information of the first terminal 220. For example, as shown in FIG. 2, the first terminal 220 transmits the routing information comprising information indicating that its own IP address is 192.168.10.3 and information indicating that the IP address of the accessible external network is 192.168.20.1 to the group owner terminal 210.

If the routing information is transmitted to the group owner terminal 210, in step 340, the group owner terminal 210 updates the routing table based on the routing information. For example, the group owner terminal 210 updates its own DG from 192.138.10.1 to 192.138.10.3 and updates the DG of the first terminal 210 from 192.168.10.1 to an IP address accessible to the external network, 192.168.20.1. The group owner terminal 210 may automatically update the routing table or the user may update the routing table by changing the DG directly.

If the routing table is updated, in step S350, the first terminal 220 tethers network connection of the group owner terminal 210 and the second terminal 230. More specifically, if the routing table is updated, as shown in FIG. 3, the IP address of the group owner terminal 210 is updated to 192.168.10.1 and the DG is updated to 192.168.10.3, the IP address of the first terminal 220 is updated to 192.168.10.3 and the DG is updated to 192.168.20.1, and the IP address of the second terminal 230 is updated to 192.168.10.2 and the DG is updated to 192.168.10.1. Accordingly, the first terminal 220 directly connects to the external network, the IP address of which is 192.168.20.1, the group owner terminal 210 is routed to the first terminal and, thus, connects to the external network, and the second terminal 220 is routed to the group owner terminal 210 and the first terminal 220 and thus connects to the external network.

According to the above-described embodiment of the present invention, even though the client terminal 220 and not the group owner terminal 210 provides the tethering function for the external network in the Wi-Fi P2P environment, the other terminals 230 including the group owner terminal 210 are also able to connect to the external network.

### 2. Method for Tethering a Network Connection by Changing a Group Owner

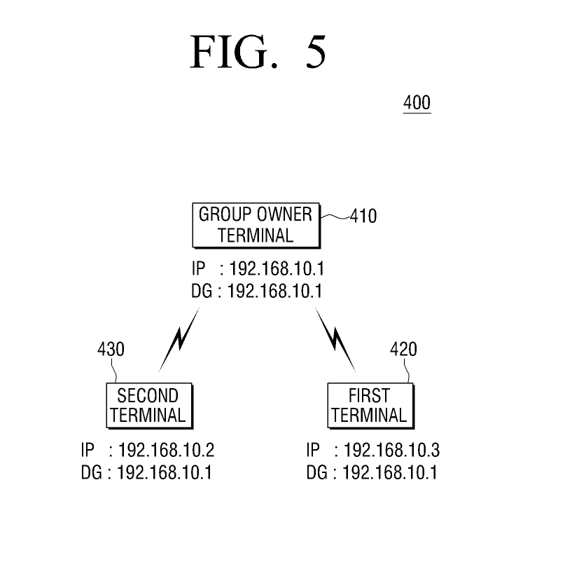

Hereinafter, a method for tethering a network connection by changing a group owner according to another embodiment of the present invention will be explained with reference to FIGS. 5 to 7.

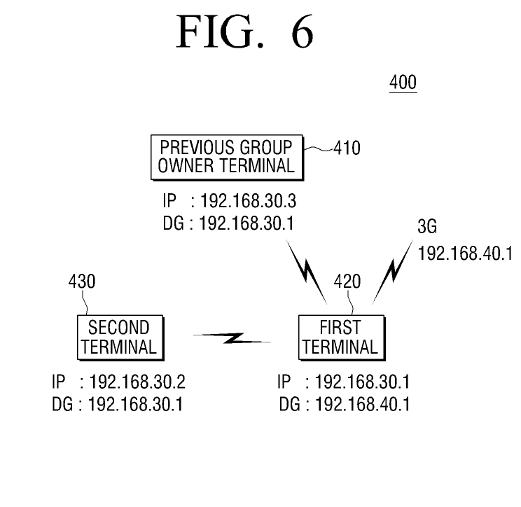

FIGS. 5 and 6 illustrate a wireless communication group 400 to tether a network connection by changing a group owner according to another embodiment. The wireless communication group 400 according to another embodiment of the present invention includes a group owner terminal 410, a first terminal 420, and a second terminal 430. The wireless communication group 400 is a communication group of a Wi-Fi P2P environment. As described above, the communication group of the Wi-Fi P2P environment does not require a separate AP unlike a traditional Wi-Fi communication group and the group owner terminal 210 performs the role of an AP of the related-art Wi-Fi communication group.

The group owner terminal 410 periodically transmits a beacon message and transmits packets to the other terminals 420 and 430 of the group, like the AP of the traditional Wi-Fi wireless communication group,

Moreover, if the group owner terminal 410 provides a tethering function for an external network, the group owner terminal 410 allows not only itself but also the first terminal 420 and the second terminal 430 to connect to the external network.

On the other hand, if the group owner terminal 410 does not provide the tethering function, the group owner terminal 410 checks whether there is the first terminal 420 that provides the tethering function among the plurality of terminals of the wireless communication group 400 through a communication unit (not shown). If the first terminal 420 providing the tethering function exists, the group owner terminal 410 transmits a group owner change message to the plurality of terminals 420 and 430 through the communication unit (not shown). If the group owner change message is transmitted, the group owner is changed to the first terminal 410 and, thus, the group owner terminal 410 does not perform the role of the group owner any longer and is changed to a general terminal. The previous group owner terminal 410 is then tethered to the new group owner, the first terminal 420, so that the group owner terminal 410 can connect to the external network.

The first terminal 420 and the second terminal 430 are wireless communication terminals that are able to connect to the external network through the group owner terminal 410 or directly connect to the external network. If the group owner terminal 410 connects to the external network and provides the tethering function, the first terminal 420 and the second terminal 430 are tethered to the group owner terminal 410 so that the first terminal 420 and the second terminal 430 can connect to the external network.

If the group owner terminal 410 does not provide the tethering function, the first terminal providing the tethering function receives the group owner change message from the group owner terminal 210 and is then changed to the group owner. The new group owner, the first terminal 420, then periodically transmits a beacon message and transmits packets to the other terminals 410 and 420 of the group. The new first terminal 420 tethers such that that the previous group owner 410 and the second terminal 430 are routed and, thus, connect to the external network, e.g., the Internet. The method for tethering the network connection by changing the group owner will be explained in detail below.

If the group owner terminal 410 does not provide the tethering function and the first terminal 420 provides the tethering function, the second terminal 430 is tethered to the first terminal 420, which is the changed group owner and connects to the external network.

The group owner terminal 410, the first terminal 420, and the second terminal 430 may establish a home wireless network environment. For example, the group owner terminal 410 may be an IPTV and the first terminal 420 and the second terminal 430 may be wireless terminal devices such as a mobile phone, an MP3 player, a PMP, and an electronic album. However, these are merely examples and the present invention may be applied to any other wireless terminal device.

Hereinafter, the method for tethering the network connection by changing the group owner according to another embodiment of the present invention will be explained in detail with reference to FIGS. 5 to 7.

As described in FIG. 2, if the group owner terminal 410 does not provide the tethering function, neither the group owner terminal 410 nor the first terminal 42 and the second terminal 430 can connect to the external terminal. More specifically, as shown in FIG. 5, in the case that the group owner terminal 410 has an IP address of 192.168.10.1 and a DG of 192.168.10.1, the first terminal 420 has an IP address of 192.168.10.3 and a DG of 192.168.10.1, and the second terminal 430 has an IP address of 192.168.10.2 and a DG of 192.168.10.1, if the group owner terminal 410 does not connect to the external network, the first terminal 420 and the second terminal 430 are not able to connect to the external network despite being routed to the group owner terminal 410, since the group owner terminal 410 does not connect to the network.

However, according to another embodiment, if the group owner terminal 410 does not provide the tethering function but if the first terminal 420 provides the tethering function, the first terminal 420 of the wireless communication group 400 is changed to the new group owner so that the previous group owner 410 and the second terminal 430 are tethered to the first terminal 420 and thus connect to the external network.

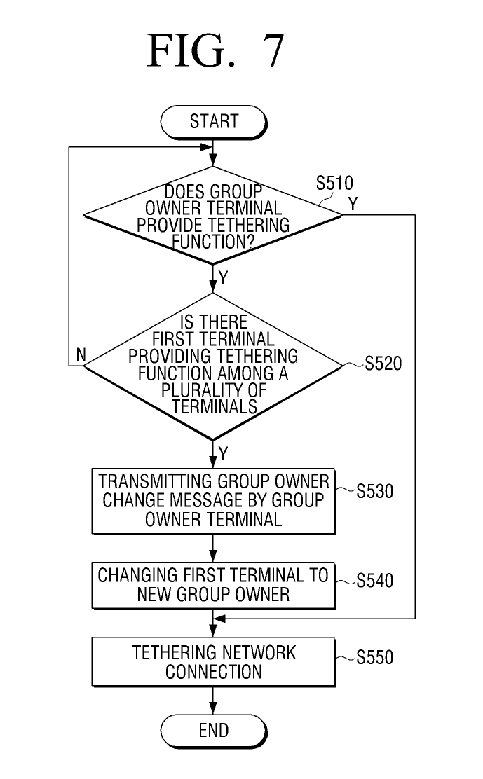

Hereinafter, a method for tethering a network connection by changing group owner according to another embodiment of the present invention will be explained with reference to FIG. 7.

FIG. 7 is a flowchart illustrating a method for tethering a network connection by changing a group owner according to another embodiment.

First, in step S510, the wireless communication group 400 checks whether the group owner terminal 410 provides the tethering function. If the group owner terminal 410 provides the tethering function, in step S550, the group owner terminal 410 tethers external network connection in a related-art wireless communication method of a Wi-Fi P2P environment.

However, if the group owner terminal 410 does not provide the tethering function, in step S520, the group owner terminal 410 checks whether there is the first terminal 420 that provides the tethering function among the plurality of terminals of the wireless communication group 400. To determine whether there is a first terminal 420 providing the tethering function, one of a method in which the group owner terminal 410 searches for the first terminal 420 connected to the network and a method in which that the first terminal 420 informs the group owner terminal 410 that the first terminal 410 can provide the tethering function may be used in the present invention.

If there is the first terminal 420 providing the tethering function for the external network, in step S530, the group owner terminal 410 transmits the group owner change message to the other terminals 420, 430 of the wireless communication group 400. The group owner change message may be transmitted with an IEEE 802.11 disassociation frame, which is a packet of a Media Access Control (MAC) layer periodically transmitted by the group owner terminal 410, or a beacon message containing the group owner change message.

If the group owner change message is transmitted, the first terminal 420 is changed to a new group owner of the wireless communication group 400 (S540). The new group owner, the first terminal 420, periodically transmits a beacon message and transmits packets to the other terminals 410 and 430 of the group. If the group owner is changed, the IP addresses and the DGs of the previous group owner terminal 410 and the second terminal 420 are changed so that the group owner terminal 410 and the second terminal 420 are routed to the first terminal 410. More specifically, the DGs of the previous group owner terminal 410 and the second terminal 430 are changed to the IP address of the first terminal 420, which is the new group owner, and, thus, the previous group owner 410 and the second terminal 420 are tethered to the first group terminal 410, which is the new group owner.

Thus, even through the group owner is changed and thus the group is reconfigured, a registrar of an existing Wi-Fi Protected Setup (WPS) is maintained as it is. This is to prevent a delay caused by the group re-configuration by maintaining the registrar of the WPS as it is.

Accordingly, in step S550, if the group owner changes, the first terminal 420, which is the new group owner, tethers such that the previous group owner terminal 410 and the second terminal 430 connect to the external network. More specifically, the previous group owner 410 and the second terminal 430 are routed to the first terminal 420, which is the new group owner, and, thus, connect to the external network. For example, as shown in FIG. 6, if the group owner is changed, the IP address of the first terminal 420, which is the new group owner providing the tethering function, is changed to 192.168.30.1 and the DG is changed to the IP address of the external network, 192.168.40.1. Moreover, the IP address of the previous group owner terminal 410 is changed to 192.168.30.3 and the DG is changed to 192.168.30.1, and the IP address of the second terminal 430 is changed to 192.168.30.2 and the DG is changed to 192.168.39.1. Thus, the previous group owner terminal 410 and the second terminal 430 are tethered to the first terminal 420 which is the new group owner and connects to the external network.

Accordingly, according to the embodiment, even though the client terminal 420 other than the group owner terminal 410 provides the tethering function for the external network in the Wi-Fi P2P environment, the other terminals 430, including the group owner terminal 410, are also able to connect to the external network.

While the invention has been shown and described with reference to certain illustrative embodiments thereof, it will be understood by those skilled in the art that various changes in form and details may be made therein without departing from the spirit and scope of the invention as defined by the appended claims and their equivalents.

What is claimed is:

1. A method for connecting a terminal included in a wireless communication group to an external network, the method comprising:
receiving routing information from a first terminal having an external network tethering function for connecting a second terminal in the wireless communication group with the external network through the first terminal;
updating a pre-stored routing table according to the received routing information; and
allowing the second terminal of the wireless communication group to use the external network through the first terminal with the updated routing table.

2. The method of claim 1, wherein the routing information comprises IP address information and default gateway information of the first terminal, and an IP address of the external network.

3. The method of claim 1, wherein updating the pre-stored routing table comprises updating a default gateway of the terminal to an IP address of the first terminal.

4. The method of claim 1, wherein the terminal is a group owner terminal of the wireless communication group.

5. The method of claim 4, wherein the group owner terminal is unable to provide a tethering function for the external network.

6. The method of claim 1, wherein the wireless communication group is a wireless communication group of a Wireless Fidelity (Wi-Fi) Peer-to-Peer (P2P) environment.

7. A method for tethering a network connection, the method comprising:
transmitting routing information to a group owner terminal by a first terminal that provides an external network tethering function among a plurality of terminals of a wireless communication group;
updating a routing table based on the routing information by the group owner terminal; and
tethering according to the updated routing table such that the group owner terminal and a second terminal of the wireless communication group connect to the external network by the first terminal.

8. A method for connecting to a network connection of a terminal included in a wireless communication group, the method comprising:
identifying a first terminal that provides an external network tethering function for connecting with the external network to a second terminal of the wireless communication group;
transmitting, to the second terminal, a group owner change message including information indicating that the first terminal will be changed to a new group owner; and
connecting the second terminal to the external network by using the new group owner.

9. The method of claim 8, wherein the group owner change message is transmitted with an IEEE 802.11 disassociation frame or a beacon message containing the group owner change message.

10. The method of claim 8, wherein connecting to the external network comprises:
updating a default gateway to an IP address of the first terminal which is the new group owner and connecting to the external network.

11. The method of claim 8, wherein if a group owner is changed, the wireless communication group maintains a registrar of an existing Wi-Fi Protected Setup (WPS) as it is.

12. The method of claim 8, wherein the terminal is a group owner terminal of the wireless communication group.

13. The method of claim 12, wherein the group owner terminal is unable to provide a tethering function for the external network.

14. The method of claim 1, wherein the wireless communication group is a wireless communication group of a Wi-Fi P2P environment.

15. A wireless communication system, the system comprising;
a first terminal for providing an external network tethering function;
a group owner terminal for identifying the first terminal, transmits a group owner change message comprising information indicating that the first terminal will be changed to a new group owner to a plurality of terminals of the wireless communication group, and is tethered to the first terminal and connects to the external network; and
a second terminal, for, if the group owner change message is received, tethering to the first terminal which is the new group owner and connects to the external network.

16. A method for tethering a network connection of a terminal included in a wireless communication group, the method comprising;
receiving, from a group owner terminal, a request in which the tethering function for connecting with an external network is provided;
informing the group owner terminal that it is possible to provide the tethering function to work as a new group owner; and
connecting a terminal connecting to the group owner terminal to the external network.

17. The method of claim 16, wherein informing the group owner terminal comprises providing routing information of the new group owner.

18. The method of claim 16, wherein the group owner terminal transmits a group owner change message for changing the new group owner to the terminal.

19. The method of claim 16, wherein receiving from a group owner terminal comprises checking whether there is a terminal that provides the tethering function.

20. The method of claim 16, wherein the terminal connects to the external network through the new group owner.
